(19) United States
(12) Patent Application Publication
(10) Pub. No.: US 2009/0001063 A1
(43) Pub. Date: Jan. 1, 2009

(54) LASER PROCESSING MACHINE WITH LASER PROCESSING NOZZLE ADJUSTMENT

(75) Inventors: Juergen-Michael Weick, Asperg (DE); Michael Haecker, Wimsheim (DE)

Correspondence Address: FISH & RICHARDSON PC, P.O. BOX 1022, MINNEAPOLIS, MN, 55440-1022, US

(73) Assignee: TRUMPF Werkzeugmaschinen GmbH + Co. KG, Ditzingen (DE)

(21) Appl. No.: 11/948,668

(22) Filed: Nov. 30, 2007

Related U.S. Application Data
(63) Continuation of application No. PCT/EP2006/005120, filed on May 30, 2006.

(30) Foreign Application Priority Data
May 31, 2005 (EP) 05011709.2

(51) Int. Cl. B23K 26/00; B23K 26/02

(52) U.S. Cl. 219/121.85; 219/121.78

(57) ABSTRACT

A laser processing machine includes a laser that outputs a laser beam, a laser processing head including a nozzle that defines a nozzle bore, a beam guidance and focusing system for directing the laser beam through the nozzle bore of the laser processing head, an illumination system that produces a light beam that is directed at the nozzle bore of the nozzle such that the light beam completely illuminates the nozzle bore, a light detector at the nozzle bore that views light that exits the nozzle bore, and an evaluation system that receives the output of the light detector and automatically determines the separation between a center of the laser beam when the laser beam is focused at the nozzle and a center of the nozzle based on the light detector output.

### CROSS REFERENCE TO RELATED APPLICATION

This application is a continuation of and claims priority under 35 U.S.C. § 120 to PCT Application No. PCT/EP2006/005120, filed on May 30, 2006, which claimed priority to EP Application No. 05 011 709.2, filed on May 31, 2005. The contents of both of these priority applications are hereby incorporated by reference in their entirety.

### TECHNICAL FIELD

The invention relates to a laser processing machine including an optics for beam guidance and for focusing of a laser processing beam.

### BACKGROUND

Laser processing machines are used for material processing and typically includes a laser processing nozzle. The laser beam in laser processing machines is positioned centrally within the laser processing nozzle. The laser processing nozzle adjustment can be performed manually.

### SUMMARY

In one general aspect, a laser processing machine includes a laser that outputs a laser beam, a laser processing head including a nozzle that defines a nozzle bore, a beam guidance and focusing system for directing the laser beam through the nozzle bore of the laser processing head, an illumination system that includes a light source that is distinct from the laser and that produces a light beam that illuminates the nozzle bore, a light detector at the nozzle bore that detects light that exits the nozzle bore, and an evaluation system that receives an output of the light detector and determines a separation between a center of the laser beam when the laser beam is focused at the nozzle and a center of the nozzle.

Implementations can include one or more of the following features. For example, the light beam can be directed to be collinear with the laser beam.

The light source can include a laser diode.

The light beam can be directed by an optical system that includes an optics that widens the light beam, a deflecting mirror that deflects the widened light beam, and a mirror that reflects the light beam deflected from the deflecting mirror so that the light beam is collinear with respect to the laser beam. The deflecting mirror and the mirror can be part of a process light measuring system.

The light detector can include a screen that receives the light that exits the nozzle bore. The light detector can record an image of the light at the screen. The light detector can receive the light that exits the nozzle bore.

The evaluation system can determine a center of a spot formed by the light beam at the light detector and a center of a spot formed by the laser beam at the light detector. The light beam can completely illuminate the nozzle bore. The beam guidance and focusing system can include an adaptive mirror.

In another general aspect, a method of laser processing includes directing a laser beam from a laser through a nozzle bore of a nozzle of a laser processing head, producing a light beam that is distinct from the laser beam of the laser, directing the light beam at the nozzle bore of the nozzle to completely illuminate the nozzle bore, detecting the light from the light beam and the laser beam that exit the nozzle bore, and determining a separation between a center of the laser beam when the laser beam is focused at the nozzle and the center of the nozzle based on the light detected from the light beam and the laser beam exiting the nozzle bore.

Implementations can include one or more of the following features. For example, directing the laser beam from the laser through the nozzle bore can include directing the laser beam through an adaptive mirror and then through a focusing optics.

Producing the light beam that is distinct from the laser beam can include producing the light beam from a laser diode.

Directing the light beam at the nozzle bore can include directing the light beam to be collinear with the laser beam. Directing the light beam at the nozzle bore can include expanding the light beam, deflecting the expanded light beam, and reflecting the deflected light beam to be collinear with the laser beam.

Determining the separation between the laser beam focus and the nozzle center can include measuring a size of a first spot formed from the light beam that passes through the nozzle to determine a center of the nozzle bore, positioning a focal position of the laser beam at a plane at a lower edge of the nozzle, determining a center of a second spot formed from the laser beam that passes through the nozzle, and automatically adjusting one or more of the laser beam focus and position to center the laser beam on the nozzle.

In another general aspect, a method of laser processing includes directing a laser beam from a laser through a nozzle bore of a nozzle of a laser processing head, defocusing the laser beam so that the laser beam completely illuminates the nozzle bore, detecting the light from the defocused laser beam that exits the nozzle bore, evaluating the detected light to determine light intensity, and automatically adjusting one or more of the laser beam position and focus and the position of the nozzle to position the laser beam at the center of the nozzle based on the evaluation.

In a further general aspect, a laser processing machine includes a laser that outputs a laser beam, a laser processing head including a nozzle that defines a nozzle bore, a beam guidance and focusing system for directing the laser beam through the nozzle bore of the laser processing head, an illumination system that produces a light beam that is directed at the nozzle bore of the nozzle such that the light beam completely illuminates the nozzle bore, a light detector at the nozzle bore that views light that exits the nozzle bore, and an evaluation system that receives the output of the light detector and automatically determines the separation between a center of the laser beam when the laser beam is focused at the nozzle and a center of the nozzle based on the light detector output.

Implementations can include one or more of the following features. For example, the illumination system can include a light source that is distinct from the laser. The illumination system can include a defocusing device that defocuses the laser beam from the laser to produce the light beam that completely illuminates the nozzle bore.

The laser processing beam can be automatically positioned centrally within a nozzle bore of a laser processing nozzle of the laser processing machine (such as a laser cutting head).

Advantageously, the nozzle center can be determined by a reference measurement, where one image of the illuminated nozzle and one image of a focused beam are recorded and evaluated. The measurement signals can be used for automatic laser nozzle centering through machine control.

A separate light source is provided for illuminating the nozzle bore. This is advantageous in that the laser beam designed for laser processing need not be adjusted. A further essential advantage of using a separate light source is the fact that visible light can be used. For this reason, detectors for visible light can be used. The detectors can be manufactured through standard production at little cost. Since the existing optics can be used to couple-in the light beam of the light source, no additional optics is required for coupling-in.

The method using a separate light source can be technically implemented with a laser diode for generating the beam, an optics for widening the beam, a deflecting mirror, and a mirror for reflecting the light beam co-linearly with respect to the laser processing beam.

When the deflecting mirror and the mirror are part of a process light measuring device, the invention can be combined with a process light measuring device, and be advantageously integrated in a laser processing machine.

An image detecting and image evaluating device is of advantage for evaluation.

The optics for beam guidance and laser beam focusing can include an adaptive mirror that can be used to adjust the illumination.

### DESCRIPTION OF THE DRAWINGS

FIG. 1 is a perspective view of a laser processing machine;

FIG. 2 is a schematic diagram of a part of the laser processing machine of FIG. 1 showing laser beam guidance and reflection of a light beam for illuminating a nozzle bore;

FIG. 3 is a schematic diagram of a part of the laser processing machine of FIG. 1 showing another implementation that includes a process light measurement;

FIG. 4 is a schematic diagram of a part of a nozzle showing the nozzle bore illuminated by a light beam;

FIG. 5 is a schematic diagram of the part of the nozzle showing the nozzle bore;

FIG. 6 is a top view of a quadrant sector; and

FIG. 7 is a schematic diagram of a part of the laser processing machine of FIG. 1 showing another implementation.

### DETAILED DESCRIPTION

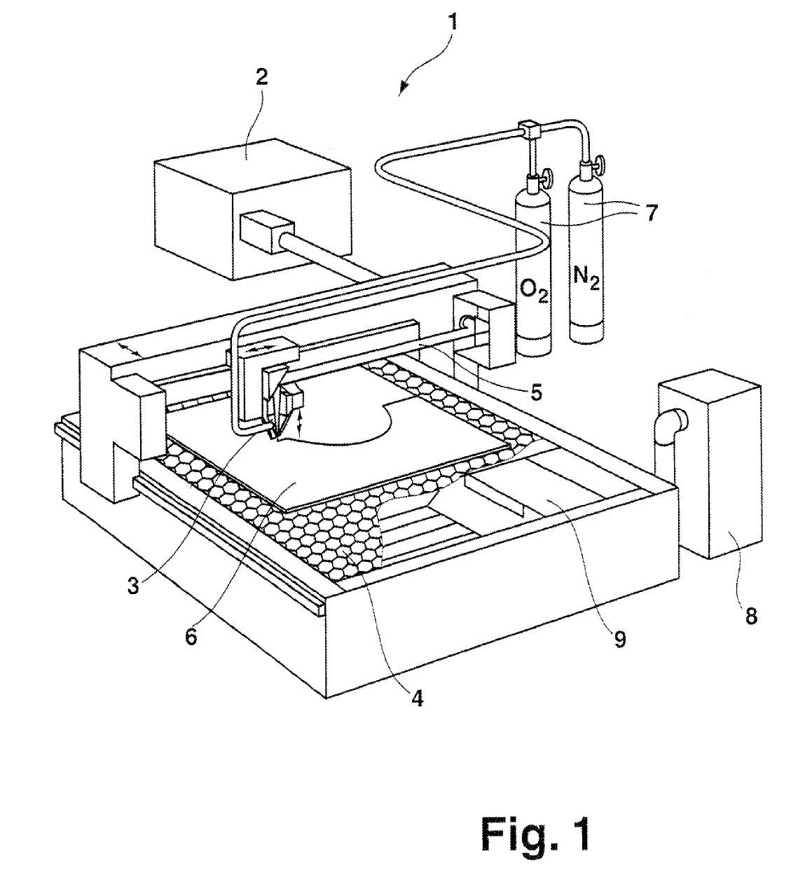

FIG. 1 shows the structure of a laser processing machine 1 for laser cutting. The laser processing machine 1 includes a laser 2 that produces a laser beam 5, a laser processing head 3 that receives the laser beam 5 from the laser 2, and a workpiece support 4 that supports a workpiece 6 (such as sheet metal). The laser 2 can be any high power pulsed laser, for example, a CO2 laser or a Nd:YAG laser. The laser beam 5 from the laser 2 is guided to the laser processing head 3 using deflecting mirrors, and the laser processing head 3 directs the laser beam 5 onto the workpiece 6 with mirrors.

The laser beam 5 penetrates through the workpiece 6 to produce a continuous kerf. The workpiece 6 is, in this example, dot-melted or oxidized at one location, and the molten mass is blown out using a cutting gas.

In case of slow piercing by a ramp, the power of the laser 2 can be gradually increased, reduced, and kept constant for a defined time period until the piercing hole is generated. Both piercing and laser cutting are supported by adding of a gas. Oxygen, nitrogen, compressed air, and/or application-specific gases can be used as cutting gases 7 that are focused or blown into the cutting region to expel or blow away molten material and vapor from the cutting path. The selection of the gas to be used depends on the materials to be cut and on the quality standards that the workpiece must meet.

At that location where the laser beam 5 is incident on the workpiece 6, the material is molten and largely oxidized. The produced molten mass is blown out together with the iron oxides. The generated particles and gases can be withdrawn into a suction chamber 9 using a suctioning means 8.

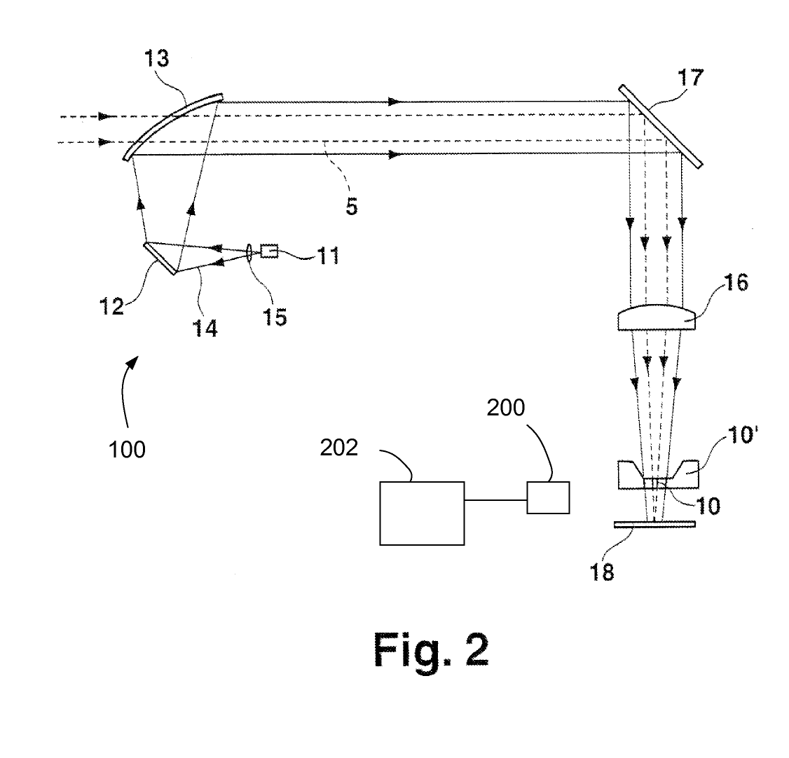

Referring to FIG. 2, the laser processing head 3 (also referred to as a cutting head 3) includes a cutting nozzle 10′ that defines a cutting nozzle bore 10. The laser processing machine 1 includes an illumination system 100 having a light source 11 that illuminates the cutting nozzle bore 10. The light source 11 can be a laser diode that produces a laser beam 14. Additionally, the illumination system 100 includes a deflecting mirror 12 disposed at an angle from the output axis of the light source 11, for example, at an angle of 45°, to deflect the laser beam, and a mirror 13 positioned in the path of the laser beam 14 deflected from the deflecting mirror 12. The mirror 13 is also in the path of the laser beam 5 so that the mirror 13 allows reflection of the laser beam 14 such that the reflected laser beam 14 is collinear with the laser beam 5 of the laser 2. Towards this end, the laser beam 14 of the light source 11 is widened with a widening lens 15 positioned near an output of the light source 11 such that the laser beam 14 is incident on or near the edge of the mirror 13. The focal distance of the widening lens 15 and its separation from the mirror 13 are selected such that a focusing optics 16 (for example, a lens or a mirror) placed downstream of the light source 11 is completely or nearly completely illuminated by the laser beam 14 of the laser diode 11.

The laser beam 14 produced by the light source 11 can be at any suitable wavelength, for example, it can be at wavelengths in the visible spectrum to facilitate the task of automated laser processing nozzle adjustment. However, the laser beam 14 can be at other wavelengths.

The focal position of the focusing optics 16 is adjusted using an adaptive mirror 17 positioned between the optics 16 and the mirror 13 until the nozzle bore 10 is completely or nearly completely illuminated by the laser beam 14. The laser beam 14 thereby grazes the edge of the nozzle bore 10.

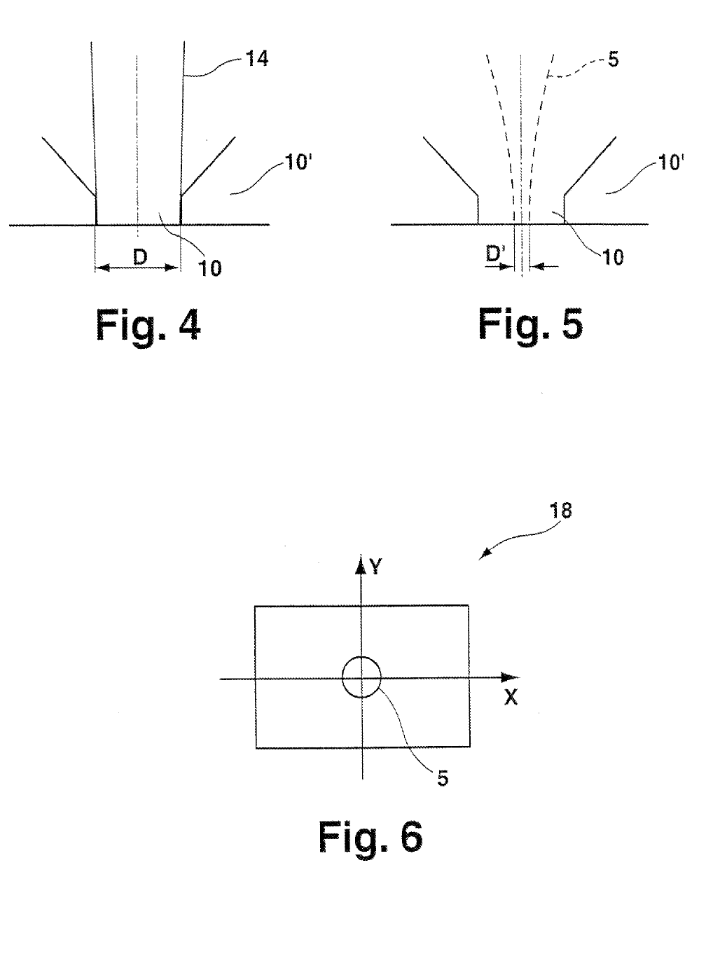

The illumination system 100 can include an image display 18, which is disposed directly below the laser cutting nozzle 10′, and which shows a spot of a diameter D (see FIGS. 4 and 5) whose boundary corresponds to the boundary of the nozzle bore 10. The image display 18 can be a ground-glass screen or any suitable screen for displaying the image of the laser beam 14. The laser processing machine 1 can include a detector 200 that detects the image at the display 18 and an evaluation system 202 that receives the output of the detector 200 and evaluates the detector output to determine the center of the nozzle 10′. The detector 200 can be a camera and the evaluation system 202 can be include processing logic and memory for analyzing information from the detector 200.

In a first step, the nozzle center of the nozzle bore 10 can be determined and evaluated the evaluation system 202 (see FIG. 4), which determines the center of the spot of diameter D (which corresponds to the center of the nozzle bore 10). In a second step, the focal position of the laser beam 5 is positioned exactly in the plane of the lower edge of the nozzle 10′ (see FIG. 5). The spot that corresponds to the focus of the laser beam 5 has a diameter D′ (for example, of approximately 0.1 mm). The center of the spot of the laser beam 5 is determined (see FIG. 5). The deviation between center of the laser beam 5 (FIG. 5) and the nozzle center as determined using the laser beam 14 can be determined and used for automatic adjustment.

The illumination system 100 can be installed in the beam guidance of the laser beam 5 at any location of the laser processing machine 1.

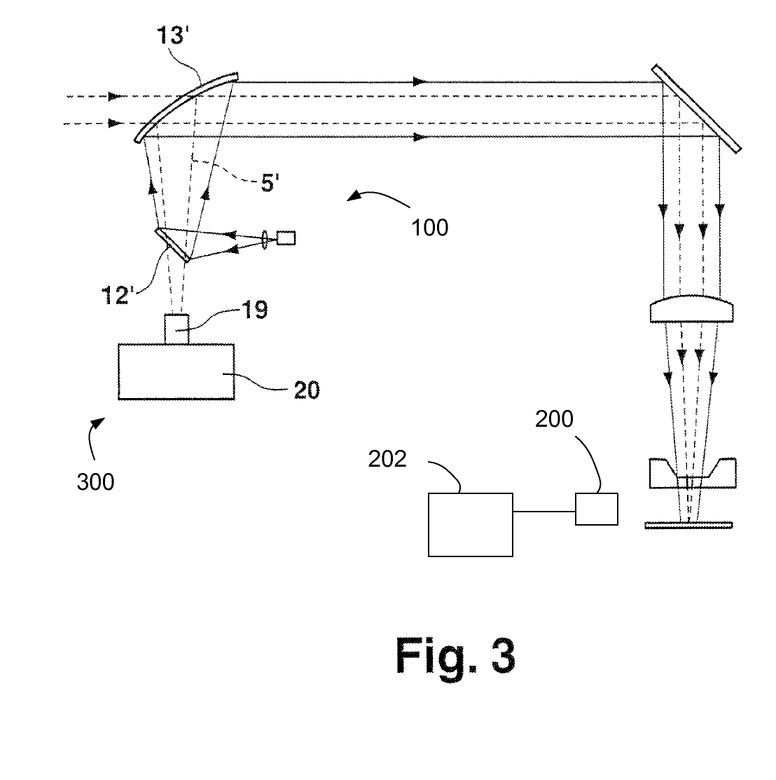

FIG. 3 shows the combination of an illumination system 100′ (similar in design to the illumination system 100) with an optical process light measuring system 300 that processes light 5′ that can be back-reflected at the workpiece 6. The illumination system 100 includes a deflecting mirror 12′ at an output of the light source 11, and a mirror 13′ in the path of the beam 14 deflected from the mirror 12′. The optical process light measuring system 300 includes a photo diode 19 that receives light and electronics 20 that processes data from the photo diode 19.

The mirror 13′ can have a hole through which the processing laser beam 5 passes. The back-reflected light beam 5′ is coupled into the beam guidance through the partially reflecting mirror 12′ and the so-called scraper mirror 13′. The mirror 13′, a (pierce control system (PCS) scraper, is a suitable mirror that is already provided in the laser processing machine 1 and can be additionally used for this purpose. The laser processing machine 1 can be provided with the optical process light measuring system 300, where the mirror 13′ is part of the process light measuring system 300. The process light measuring system 300 can be conventionally constructed. Measuring systems of this type are distributed, e.g., by TRUMPF GmbH+Co. KG of Ditzingen, Germany, under the name “PCS”. PCS (or pierce control system) is an optical system that measures the process light during piercing (which is a step that can take place prior to laser cutting). In accordance with the selected function in the DIAS-PCS-PC, the piercing process can be controlled using measurement values (soft piercing) and/or the piercing end can be detected (soft and full piercing).

Back-reflected process light 5′ that is generated at the position on the workpiece 6 that is being pierced due to the laser power beam is guided with the scraper mirror 13′ to the photo diode 19, which converts the intensity of the light 5′ into a corresponding current. The electronics 20 in the measuring head measures the current from the photo diode 19 and transmits these measurement values in a digital fashion to evaluation electronics that continues to process this data in a corresponding fashion.

In another implementation, instead of the laser beam 14, a weakened laser processing beam 5 can also (or alternatively) be used for illuminating the nozzle bore 10. In this case, a CO₂ laser light-sensitive camera or at least a CO₂ laser light-sensitive quadrant detector can be used as the sensor at the output of the nozzle bore 10 if the laser 2 is a CO₂ laser.

The quadrant detector can be used as follows.

In a first implementation, the laser beam 5 is defocused until it fills the nozzle bore 10 of the laser processing head 3. The laser beam 5 is displaced using the optical elements of the beam guidance (for example, using mirror 13, mirror 17, and/or focusing optics 16) until the signal, e.g., in the −X-quadrant disappears.

The value of the displacement is stored. The value in +X-direction is subsequently determined by movement along the X-axis. The center of the nozzle 10′ is the average value of the two obtained values. Displacement in the Y-direction is performed analogously. Then, the focal point of the beam 5 is imaged on the image detector or display 18 by means of the mirror 17. The adjustment means in the laser processing head 3 is then adjusted such that all four quadrants display the same measurement values (see FIG. 6). The laser beam 5 is centered.

In a second implementation, when the focusing optics 16 is stationary, the nozzle 10′ can be moved. The small imaged beam 5 is displaced on the image detector or display 18, such that all four quadrants of the image detector or display 18 display the same measurement value. The laser beam 5 is then enlarged through defocusing by the mirror 17, such that it fills the nozzle bore 10. The nozzle 10′ is then adjusted with respect to both axes (the X- and Y-axes) until all four quadrants show the same measurement value.

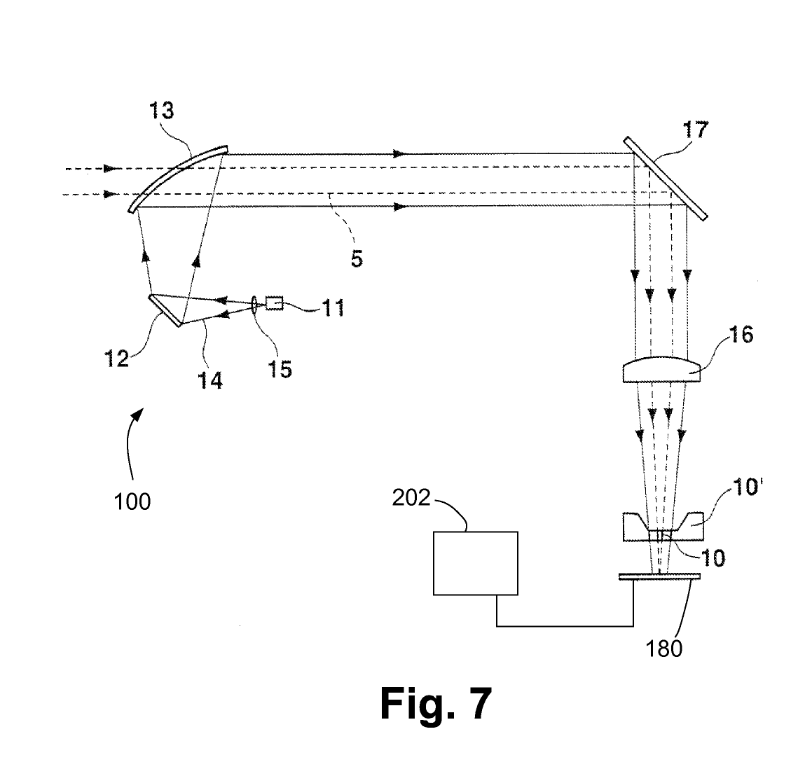

Referring also to FIG. 7, in other implementations, the image display 18 can alternatively be an image display and detector 180 that can both display the light and sense the light impinging upon its surface from the laser beam 14 and the laser beam 5 (for example, the image display and detector 180 can include a camera). In these implementations, the evaluation system 202 can be directly connected to image display and detector 180.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A laser processing machine comprising:
a laser that outputs a laser beam;
a laser processing head including a nozzle that defines a nozzle bore;
a beam guidance and focusing system for directing the laser beam through the nozzle bore of the laser processing head;
an illumination system that includes a light source that is distinct from the laser and that produces a light beam that illuminates the nozzle bore;
a light detector at the nozzle bore that detects light that exits the nozzle bore; and
an evaluation system that receives an output of the light detector and determines a separation between a center of the laser beam when the laser beam is focused at the nozzle and a center of the light beam that indicates a center of the nozzle bore.

2. The laser processing machine of claim 1, wherein the light beam is directed to be collinear with the laser beam.

3. The laser processing machine of claim 1, wherein the light source includes a laser diode.

4. The laser processing machine of claim 1, wherein the light beam is directed by an optical system that includes:
an optics that widens the light beam,
a deflecting mirror that deflects the widened light beam, and
a mirror that reflects the light beam deflected from the deflecting mirror so that the light beam is collinear with respect to the laser beam.

5. The laser processing machine of claim 4, wherein the deflecting mirror and the mirror are part of a process light measuring system.

6. The laser processing machine of claim 1, wherein the light detector includes a screen that receives the light that exits the nozzle bore.

7. The laser processing machine of claim 6, wherein the light detector records an image of the light at the screen.

8. The laser processing machine of claim 1, wherein the light detector receives the light that exits the nozzle bore.

9. The laser processing machine of claim 1, wherein the evaluation system determines a center of a spot formed by the light beam at the light detector and a center of a spot formed by the laser beam at the light detector.

10. The laser processing machine of claim 1, wherein the light beam completely illuminates the nozzle bore.

11. The laser processing machine of claim 1, wherein the beam guidance and focusing system comprises an adaptive mirror.

12. A method of laser processing, the method comprising:
directing a laser beam from a laser through a nozzle bore of a nozzle of a laser processing head;
producing a light beam that is distinct from the laser beam of the laser;
directing the light beam at the nozzle bore of the nozzle to completely illuminate the nozzle bore;
detecting the light from the light beam and the laser beam that exit the nozzle bore; and
determining a separation between a center of the laser beam when the laser beam is focused at the nozzle and the center of the nozzle based on the light detected from the light beam and the laser beam exiting the nozzle bore.

13. The method of claim 12, wherein directing the laser beam from the laser through the nozzle bore includes directing the laser beam through an adaptive mirror and then through a focusing optics.

14. The method of claim 12, wherein producing the light beam that is distinct from the laser beam includes producing the light beam from a laser diode.

15. The method of claim 12, wherein directing the light beam at the nozzle bore includes directing the light beam to be collinear with the laser beam.

16. The method of claim 15, wherein directing the light beam at the nozzle bore includes:
expanding the light beam;
deflecting the expanded light beam; and
reflecting the deflected light beam to be collinear with the laser beam.

17. The method of claim 12, wherein determining the separation between the laser beam focus and the nozzle center includes:
measuring a size of a first spot formed from the light beam that passes through the nozzle to determine a center of the nozzle bore;
positioning a focal position of the laser beam at a plane at a lower edge of the nozzle;
determining a center of a second spot formed from the laser beam that passes through the nozzle; and
automatically adjusting one or more of the laser beam focus and position to center the laser beam on the nozzle.

18. A method of laser processing, the method comprising:
directing a laser beam from a laser through a nozzle bore of a nozzle of a laser processing head;
defocusing the laser beam so that the laser beam completely illuminates the nozzle bore;
detecting the light from the defocused laser beam that exits the nozzle bore;
evaluating the detected light to determine light intensity; and
automatically adjusting one or more of the laser beam position and focus and the position of the nozzle to position the laser beam at the center of the nozzle based on the evaluation.

19. A laser processing machine comprising:
a laser that outputs a laser beam;
a laser processing head including a nozzle that defines a nozzle bore;
a beam guidance and focusing system for directing the laser beam through the nozzle bore of the laser processing head;
an illumination system that produces a light beam that is directed at the nozzle bore of the nozzle such that the light beam completely illuminates the nozzle bore;
a light detector at the nozzle bore that views light that exits the nozzle bore; and
an evaluation system that receives the output of the light detector and automatically determines the separation between a center of the laser beam when the laser beam is focused at the nozzle and a center of the nozzle based on the light detector output.

20. The laser processing machine of claim 19, wherein the illumination system includes a light source that is distinct from the laser.

21. The laser processing machine of claim 19, wherein the illumination system includes a defocusing device that defocuses the laser beam from the laser to produce the light beam that completely illuminates the nozzle bore.
